(19) United States
(12) Patent Application Publication
(10) Pub. No.: US 2025/0259614 A1
(43) Pub. Date: Aug. 14, 2025

(54) Large-Scale Surface-Vibration Sound Production and Noise Cancellation Apparatus

(71) Applicant: Vincent Loccisano, Wellesley, MA (US)

(72) Inventor: Vincent Loccisano, Wellesley, MA (US)

(21) Appl. No.: 19/192,965

(22) Filed: Apr. 29, 2025

(51) Int. Cl. G10K 11/178; H04R 17/00

(52) U.S. Cl. CPC G10K 11/17821; G10K 11/17857; H04R 17/00; H04R 2499/13

(57) ABSTRACT

A system and method for generating localized sound in a vehicle using large-scale surface-vibration technology has piezoelectric exciters in a phased array, asymmetrically embedded in the laminated glass layers of vehicle glass. Each phased array is configured to produce localized sound and/or localized sound cancellation, providing differing audio experiences for each passenger or group of passengers.

### TECHNICAL FIELD

The present disclosure relates generally to acoustics and vehicle design, and specifically to the application of large-scale surface-vibration technology to vehicle surfaces such as windows for sound production and noise cancellation.

### BACKGROUND OF THE INVENTION

Vehicle speakers rely on magnet-and-coil technology to produce sound. Typical vehicle loudspeakers are heavy and limited to producing sound in a direction determined by their permanently mounted position. Sound from speakers of this sort can be localized only by moving or rotating the speaker.

Piezoelectric materials generate an electrical charge when pressure is applied to them, and deform when an electrical voltage is applied. Asymmetric piezoelectric exciters are shaped to optimize the direction and intensity of sound waves produced when an electrical charge is applied.

By strategically placing and controlling multiple piezoelectric exciters, it is possible to create distinct areas of sound within a space. This is achieved by manipulating the phase and amplitude of sound waves that are emitted by each piezoelectric exciter. This effectively creates sound zones, where sound is focused or attenuated.

Piezoelectric exciters can function as microphones. As sound waves impact a piezoelectric exciter, the sound waves cause the exciter to vibrate. The vibration generates an electrical charge in the piezoelectric material, which is then converted to an electrical signal that can be amplified and processed. Piezoelectric microphones are highly sensitive, able to detect even faint sounds, and can capture a wide range of frequencies.

The shape of an asymmetric piezoelectric exciter influences the direction and pattern of its vibrations. The orientation of piezoelectric exciters produces desired sound-wave patterns. Furthermore, piezoelectric materials can vibrate in different modes, and the asymmetric design can be used to emphasize certain modes that produce directional sound.

A phased array involves multiple piezoelectric exciters whose signals are controlled in phase to create a focused and steerable sound wave. Sound waves in phase may be configured to be creative, to increase sound in a specific location; or they may be destructive, cancelling sound in a specific location.

Active Noise Cancellation (ANC) is a technology that effectively reduces unwanted ambient noise by generating an anti-sound signal, which is a sound signal that is precisely out of phase with received vibrations. This anti-sound signal, when combined with ambient noise, results in destructive interference, canceling out the unwanted sound. ANC systems typically use microphones to detect ambient noise, as well as electronic circuitry to generate the anti-sound signal, and speakers to emit the anti-sound.

Automobile electronics, including computers, electrical cables, and software protocols, are together known as a controller-area network (CAN), or CANbus. A CAN is a vehicle's main computer system. Through the CANbus, data travels through the system to the many subsystems such as those controlling the engine, the transmission, doors, windows, and other subsystems. Each of these subsystems is controlled by an electronic control unit (ECU). Current vehicles may have fifty or more ECUs, each able to sense signals indicating, for example: acceleration at various angles; voltage; pressure; braking; vehicle roll and yaw; steering angle; temperature, and other variables. The CANbus routes signals from sensors to computers as communicated by each ECU. An ECU can monitor voltage used by a subsystem and communicate that information through the CANbus to actuate, for instance, stopping a power-sliding door from closing on a passenger's limb, or adjusting a fuel injector's performance.

Adding to or changing a vehicle's electronic features once required extensive wiring. With the development of CAN in the last forty years, feature development (such as adding passenger-controlled climate options) has become physically easier because each new feature can now be added by programming new computer code into the CAN. Now, all vehicle features as well as vehicle diagnostics are controlled via CAN, which uses a standardized protocol called OBD-II. New features can be integrated into a vehicle by developing and uploading an algorithm into the vehicle's CAN.

There remains a need for an effective system and method that creates a first localized sound in specific areas of a vehicle and cancelling the first localized sound while generating a second localized sound in other areas of the vehicle.

### SUMMARY OF THE INVENTION

A system and method for generating localized sound in a vehicle using large-scale surface-vibration technology has piezoelectric exciters in a phased array, asymmetrically embedded in the laminated glass layers of vehicle glass. Each phased array is configured to produce localized sound and/or localized sound cancellation, providing differing audio experiences for each passenger or group of passengers.

A number of piezoelectric exciters are arranged in a pattern to create a phased array. Glass surfaces may receive vibrations wherein one or more piezoelectric exciters in the phased array may function as a microphone, or alternatively may produce vibrations, with the glass functioning as a speaker. In most embodiments of the instant invention, the piezoelectric exciters in the phased array lie outside a driver's viewing area. By arranging multiple piezoelectric exciters in an array, the phase, amplitude and direction of the sound waves emitted by each exciter may be carefully controlled. By adjusting the phase of signals sent to each exciter, sound waves may be made to constructively interfere in desired directions, creating a focused sound beam. Conversely, sound waves may be made to destructively interfere in other directions, thus reducing sound levels in those areas.

Piezoelectric exciters receive vibrations in the glass to detect sound generated by other piezoelectric exciters, as well as ambient sound in the vehicle. A computer application processes the sound to generate an anti-sound, which is a sound signal that is out of phase with the target, in this case recorded, sound. Anti-sound waves cancel out the sound generated by other piezoelectric exciters, as well as the ambient sound in the vehicle, and direct the anti-sound to a specific location and area size in the vehicle by exciting specific piezoelectric exciters in the phased array.

Each phased array may be directed to specific areas in the vehicle cabin. In an example embodiment at least one piezoelectric exciter receives sound vibrations that may include transmission and engine noise. The received sound vibrations are sent to a computer for processing. In some embodiments the sound vibrations are sent to the vehicle CAN for processing in software stored in the on-board computer in the CAN. Engine and transmission noise are of a known frequency and volume at a given speed. This known frequency and volume are compared with the received sound vibrations and used to create anti-noise, which in turn is directed to the phased array to generate and project the anti-noise to cancel the engine and transmission noise. The phased array then projects this anti-noise to specific areas of the cabin to create an experience devoid of engine and transmission noise for each passenger in the vehicle. A similar process may be performed for recorded music. Recorded music is processed through the software in the vehicle CAN and anti-noise is generated and produced through the phased array where it is directed to specific areas of the vehicle so that those not wishing to hear the music will be surrounded by localized anti-noise canceling the recorded music.

While engine noise and ambient music is canceled, a phased array may also be employed to generate music and direct that music to specific areas of the vehicle.

### BRIEF DESCRIPTION OF DRAWINGS

FIG. 1 shows the embodiment 100 as installed on vehicle glass.

FIG. 2 is a top view and detail view of the example embodiment 100.

FIG. 3 is a perspective view of the embodiment on the interior of a vehicle.

FIG. 4. is a perspective view of the embodiment on the interior of a vehicle.

FIG. 5 is a diagram depicting a method 200 of the embodiment.

FIG. 6 is a diagram depicting a method 300 of the embodiment.

### DETAILED DESCRIPTION

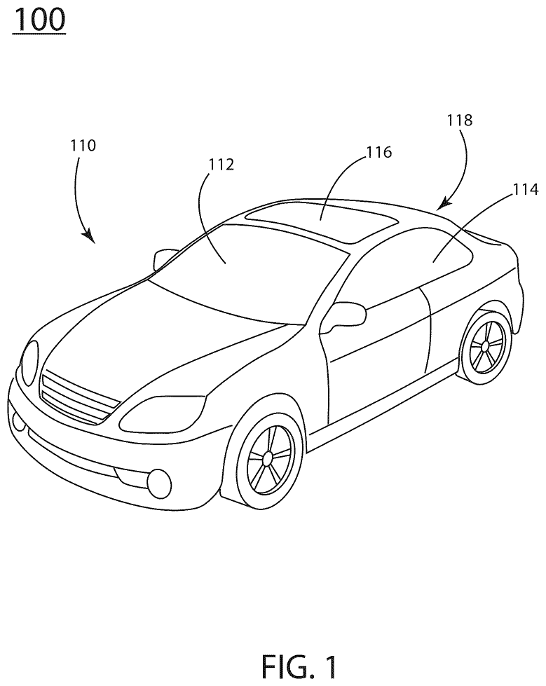

FIG. 1 is an illustration of an example embodiment 100. A vehicle 110 has a windshield 112, side windows 114 a sunroof 116 and rear window 118 outfitted with piezoelectric phased arrays for receiving and generating sound vibrations.

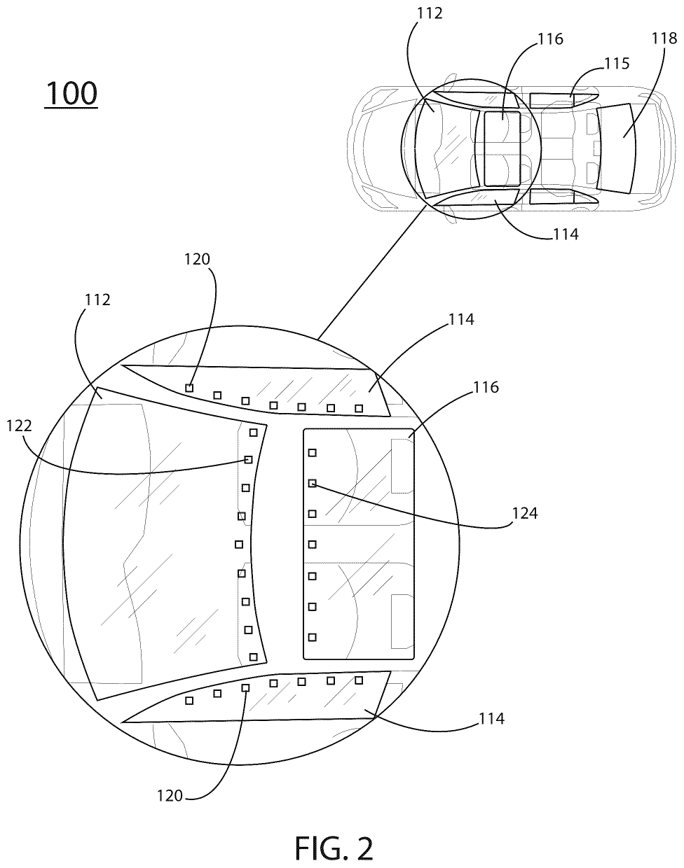

FIG. 2 is a top view and detail view of an example embodiment 100 showing a vehicle, illustrating a first phased array 120 on side windows 120, a second phased array 122 on a windshield 112 and a third phased array 124 on a sunroof 116. One skilled in the art understands that additional phased arrays may be fitted to rear-side windows, rear windows or several side windows in a van, for example.

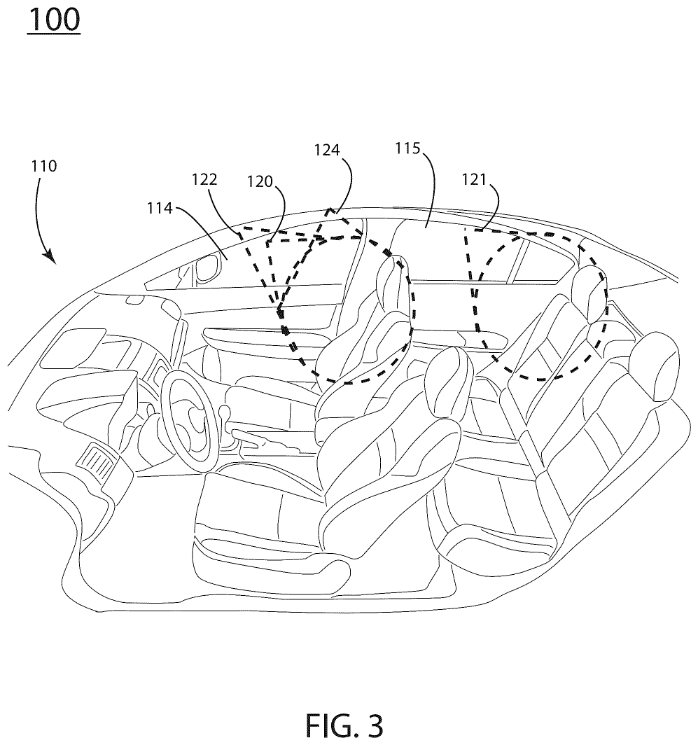

In FIG. 3, an embodiment 100 shows the interior of a vehicle 110. In this example, the phased array on the front side window 120, the windshield 122 and the sunroof 124 are producing a first sound, also referred to as music in a digital format, and directing the sound to the area surrounding the front passenger seat. The music in a digital format is stored in software in an onboard processor in the CAN that processes the music in digital format and generates anti-sound. In this example, the anti-sound is produced by the phased array 121 in a rear window 115 and directed to the area surrounding the rear passenger-seat. In this example the sound produced and directed toward the front passenger-seat is canceled by the anti-sound and not heard in the area surrounding the rear passenger-seat.

At least one piezoelectric exciter in a phased array 121 in a rear window 115 receives vibrations through the rear window 115. The received vibrations are sent to an on-board processor in the vehicle CAN that processes the received vibrations and generates anti-sound. The anti-sound is produced by the phased array 121 and directed to the area surrounding the rear passenger seat. The phased array 121 in the rear window 115 may then generate sound that is directed to the area surrounding the rear passenger seat. In this example, a passenger in the front passenger seat may hear sounds that the passenger in the rear passenger seat does not hear. At the same time a passenger in the rear passenger seat is listening to different sounds than the passenger in the front passenger seat.

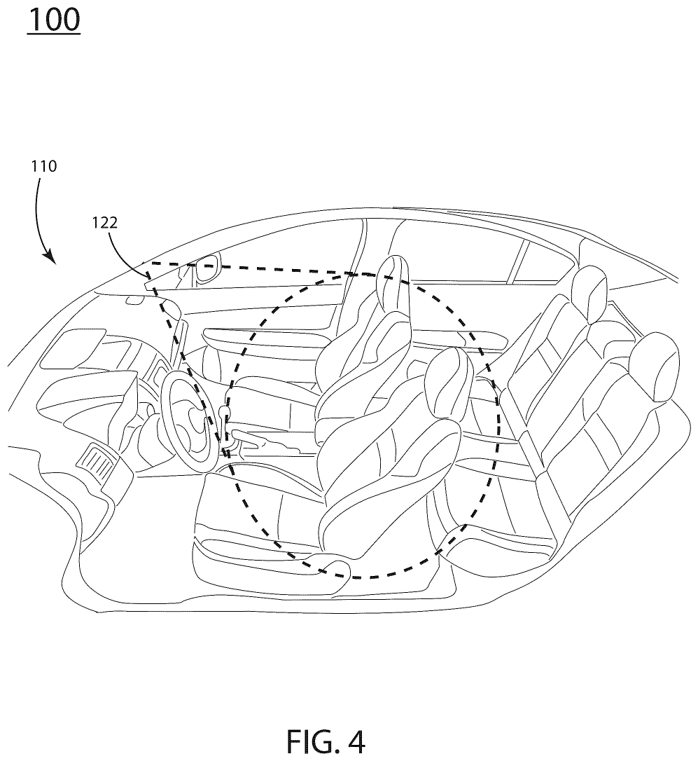

FIG. 4 illustrates another example embodiment wherein the sound of the vehicle transmission and engine are recorded in the onboard processor in the vehicle CAN at each speed and gear ratio. The sounds are processed to generate anti-sound which is then projected from a phased array, in this example from the phased array in the windshield 122. The anti-sound is projected throughout the vehicle. In this example the passengers enjoy a quiet experience. One skilled in the art understands that the sound configuration of FIG. 3 may also be engaged with the engine and transmission anti-sound playing simultaneously.

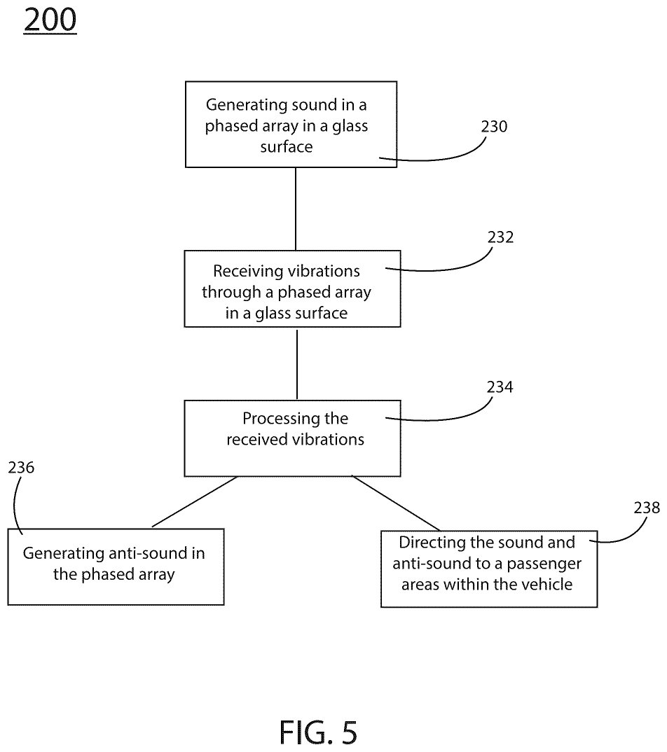

FIG. 5 is a diagram of a method of using the apparatus of FIG. 1, FIG. 2, FIG. 3 and FIG. 4. In this example embodiment 200, the method involves the steps of generating sound in a phased array that is made up of piezoelectric exciters that are arranged in an array and embedded in the glass layers 230 of a vehicle window. The sounds may be from onboard electronics, bluetooth connection to passenger's personal electronics or the like. The method continues by receiving vibrations through the same or similar phased array in a glass surface 232 and processes the received vibrations. The method continues by generating anti-sound from the processed vibrations, and projecting the anti-sound through the phased array and through the glass 236 and further directing the generated sound 230 and the generated anti-sound 236 to passenger areas of the vehicle 238.

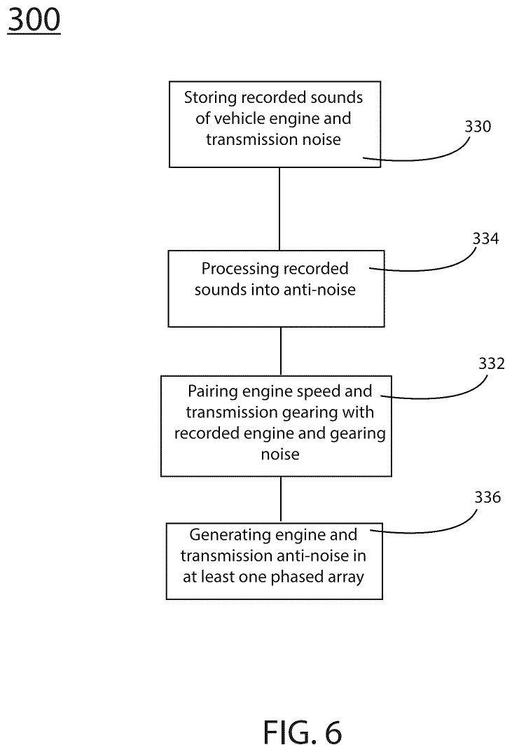

FIG. 6 is a diagram of another method of using the apparatus of FIG. 1, FIG. 2, FIG. 3 and FIG. 4. In this example embodiment 300, the method involves the steps of storing recorded sounds of vehicle engine and transmission noise at each speed and transmission gear 330. The sounds are processed and anti-noise is generated 334. The method continuous by pairing engine and transmission speed ang gearing with the recorded engine and transmission noise of the same speed and gearing 332. The method then proceeds by generating engine and transmission anti-noise in one or more of the phased arrays in the vehicle windows 336.

1. An apparatus for generating and directing sound and anti-sound comprising:
a phased array of piezoelectric exciters embedded in layers of glass; and
a processor storing an application electrically coupled with the phased array of piezoelectric exciters; wherein
the piezoelectric exciters vibrate the glass and alternatively receive vibrations from the glass for processing in the processor to produce and generate sound vibrations and anti-sound vibrations.

2. The apparatus of claim 1 wherein:
sound is directed by the phased array to a specific area in proximity of the glass.

3. The apparatus of claim 1 wherein:
anti-sound is directed by the phased array to a specific area in proximity of the glass.

4. The apparatus of claim 1 wherein:
the glass is a vehicle window.

5. The apparatus of claim 4 wherein:
the phased array is arranged in a pattern along an edge of the vehicle window.

6. A method of using the apparatus of claim 1, the method comprising:
producing sound in the application and generating the sound in the phased array; and
receiving vibrations through the phased array; and
processing the vibrations; and
generating anti-sound based on the processed vibrations; and
directing sound and anti-sound to areas proximal to the glass.

7. A method of using the apparatus of claim 1, the method comprising:
storing recorded sounds of a vehicle's engine and transmission noise; and
processing recorded sounds to generate anti-noise; and
pairing engine speed and transmission gearing with recorded engine and gearing noise; and
generating engine and transmission anti-noise in at least one phased array;
wherein
the sound of the engine and transmission are canceled in a vehicle cabin.

8. An apparatus for generating and directing sound and anti-sound comprising:
a phased array of piezoelectric exciters embedded in layers of glass across an edge of at least one window in a vehicle; and
a processor storing an application electrically coupled with the phased array of piezoelectric exciters; and
a recording of engine and transmission noise stored in the application; and
the recording processed to generate anti-noise; wherein
the anti-noise is played through the piezoelectric exciters which in turn vibrate the glass to produce and generate anti-sound to cancel the engine and transmission noise.

9. The apparatus of claim 8 wherein:
the anti-sound is directed by the phased array to specific areas of an interior of the vehicle; wherein
a quiet experience is created for each passenger.
